(19) United States
(12) Patent Application Publication
(10) Pub. No.: US 2026/0057476 A1
(43) Pub. Date: Feb. 26, 2026

(54) MACHINE LEARNING VIDEO RESOLUTION ADJUSTMENT

(71) Applicant: Adobe Inc., San Jose, CA (US)

(72) Inventors: Difan Liu, Amhert, MA (US); Yiran Xu, San Jose, CA (US); Yang Zhou, Mountain View, CA (US); Taesung Park, San Fransico, CA (US); Richard Zhang, San Francisco, CA (US); Feng Liu, Portland, OR (US); Elya Schechtman, Seattle, WA (US); Jia-Bin Huang, San Jose, CA (US)

(73) Assignee: Adobe Inc., San Jose, CA (US)

(21) Appl. No.: 18/815,814

(22) Filed: Aug. 26, 2024

(51) Int. Cl. G06T 3/4046; G06T 3/18; G06T 5/20; G06T 5/60; G06T 5/70; G06T 7/246

(52) U.S. Cl. CPC G06T 3/4046; G06T 3/18; G06T 5/20; G06T 5/60; G06T 5/70; G06T 7/246; G06T 2207/10016; G06T 2207/20081; G06T 2207/20084

(57) ABSTRACT

Machine learning video resolution adjustment techniques are described. An input digital video is received having a plurality of frames and processed by one or more machine-learning models using a processing device. The processing is performed such that the input digital video having frames in a first resolution is adjusted into an output digital video having the frames in a second resolution. Examples of processing include use of a flow guided feature propagation module, anti-aliasing blocks, and/or a high-frequency shuttle.

### BACKGROUND

Video resolution approaches are typically utilized by a computing device to upsample frames of a digital video, i.e., to increase a resolution of the frames. Conventional techniques to do so, however, encounter numerous technical challenges. These technical challenges result in visual artifacts that are readily noticeable to a human being, examples of which include blurriness and temporal flickering. As a result, conventional techniques used for upsampling digital videos as implemented by computing devices fail in real world scenarios to achieve an intended purpose of a visually pleasing digital video with increased resolution.

### SUMMARY

Machine learning video resolution adjustment techniques are described. An input digital video is received having a plurality of frames and processed by one or more machine-learning models using a processing device. The processing is performed such that the input digital video having frames in a first resolution is adjusted into an output digital video having the frames in a second resolution. Examples of processing include use of a flow guided feature propagation module, anti-aliasing blocks, and/or a high-frequency shuttle.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ machine learning video resolution adjustment techniques described herein.

FIG. 2 depicts a system in an example implementation showing operation of a video resolution system of FIG. 1 in greater detail as adjusting resolution of frames of an input digital video to produce an output digital video.

FIG. 3 depicts a system in an example implementation showing operation of a generative adversarial network of FIG. 2 in greater detail as processing low-resolution frames of an input digital video to form an output digital video having high-resolution frames.

FIG. 4 depicts a system in an example implementation showing operation of a temporal attention layer of FIG. 2 in greater detail as implemented in a decoder of the generative adversarial network of FIG. 2.

FIG. 5 depicts a system in an example implementation showing the anti-aliasing operation of FIG. 2 in greater detail.

FIG. 6 is a flow diagram depicting an algorithm as a step-by-step procedure in an example implementation of operations performable for accomplishing a result of video resolution adjustment using machine learning.

FIG. 7 is a flow diagram depicting an algorithm as a step-by-step procedure in an example implementation of operations performable for accomplishing a result of video resolution adjustment using flow guided feature propagation.

FIG. 8 is a flow diagram depicting an algorithm as a step-by-step procedure in an example implementation of operations performable for accomplishing a result of video resolution adjustment using anti-aliasing blocks and one or more high-frequency shuttles.

FIG. 9 illustrates an example system including various components of an example device that can be implemented as any type of computing device as described and/or utilize with reference to the previous figures to implement embodiments of the techniques described herein.

### DETAILED DESCRIPTION

### Overview

Resolution adjustment of frames of a digital video as implemented by a computing device encounters numerous technical challenges in addition to those encountered in increasing resolution of an independent digital image. Video resolution adjustment of a digital video, for instance, by a computing device is challenged with maintaining temporal consistency between output frames, e.g., to provide an appearance of smooth and consistent motion. A second challenge is to generate high-frequency details in the upsampled frames.

Conventional techniques used to address the first technical challenge, however, typically yield blurry results and fail to produce high-frequency appearance details, realistic textures, and so forth. Conventional techniques are also limited in a generative capability and as a result are unable to hallucinate detailed appearances.

Accordingly, to address these and other technical challenges machine learning video resolution adjustment techniques are described. The video resolution adjustment techniques are configured to change a resolution of frames of a digital video (e.g., to raise or lower) in a manner that supports detailed appearances and realistic textures while maintaining temporal consistency between frames of the digital video, which is not possible in conventional techniques.

To do so, a video resolution system is configurable to implement a variety of functionalities. Examples of these functionalities include use of a flow guided feature propagation module, anti-aliasing blocks, and/or a high-frequency shuttle. As a result, the video resolution system is able to significantly approve temporal consistency with fine-grained details in comparison with conventional techniques and may do so even for technically challenging scenarios, including those that involve upsampling of eight or more times.

A flow guided feature propagation module, for instance, is configured to augment frames of an input digital video with features aligned by optical flow. For example, the flow guided feature propagation module is configurable to produce temporal aware features that are then used by a generative adversarial network (GAN), instead of directly processing the frames of the input digital video by the generative adversarial network.

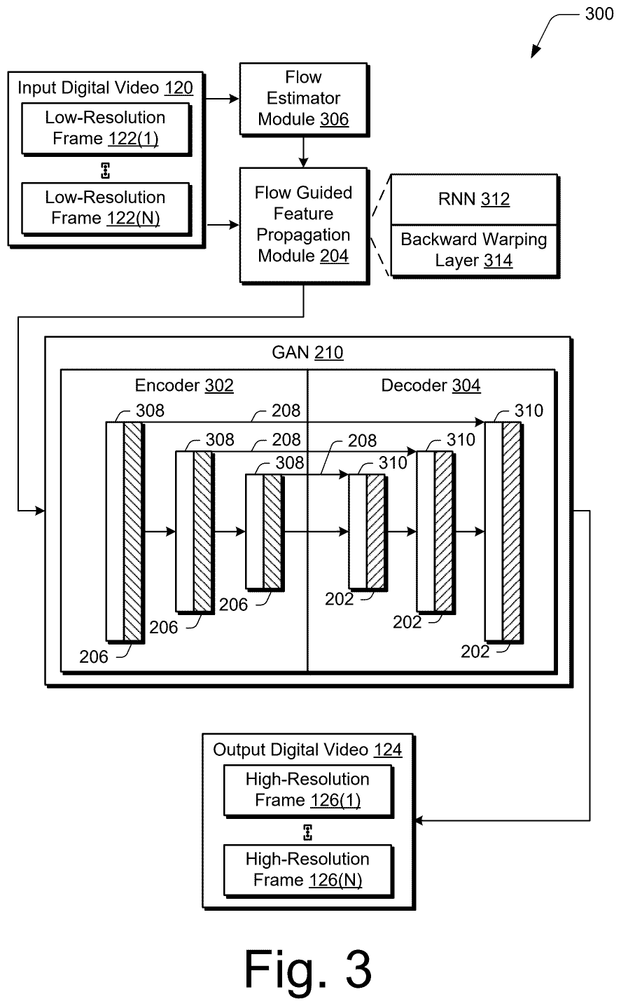

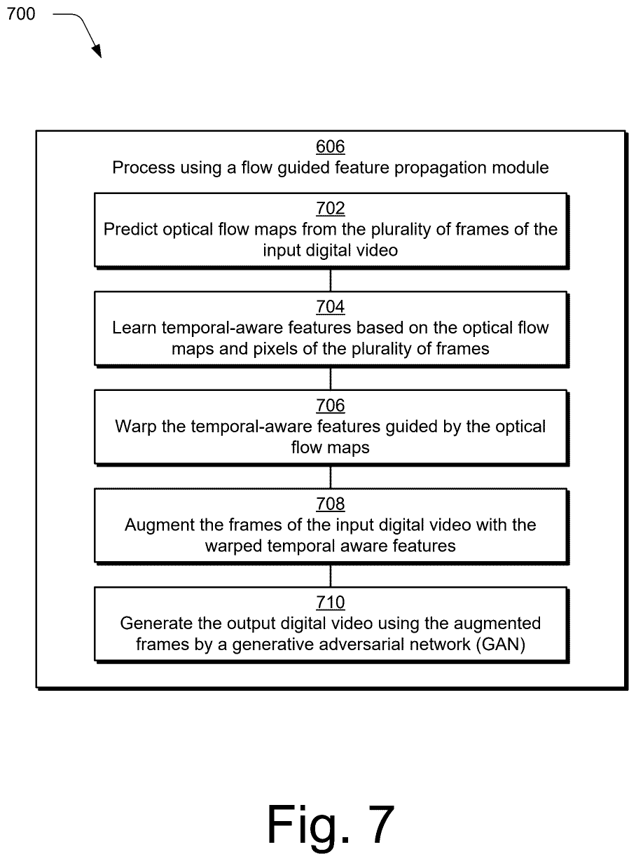

To do so in one or more examples, a bi-directional recurrent neural network (RNN) is utilized along with an image backward warping layer. An optical flow estimator is used to predict bi-directional optical flow maps which are used along with pixel values by the bi-directional recurrent neural network (RNN) to learn temporal aware features. The temporal aware features are then warped using the backward warping layer, which are guided by the optical flow maps. In an implementation, the flow guided feature propagation module is trained jointly with the generative adversarial network. As a result, the flow guided feature propagation module is configurable to handle relatively large amounts of motion between frames of the digital video and supports increased temporal consistency when compared with conventional techniques. Further discussion of operation of the flow guided feature propagation module may be found in relation to FIGS. 3 and 7.

In another example, anti-aliasing blocks are employed by a video resolution system. It has been identified that downsampling operations in an encoder (e.g., of a generative adversarial network) can contribute to visual artifacts in regions of frames that include high-frequency components, e.g., exhibit significant changes in pixel intensities between adjacent pixels. Conventional techniques used to address this technical challenge remove high-frequency details, and as a result, introduce visual artifacts such as blurriness.

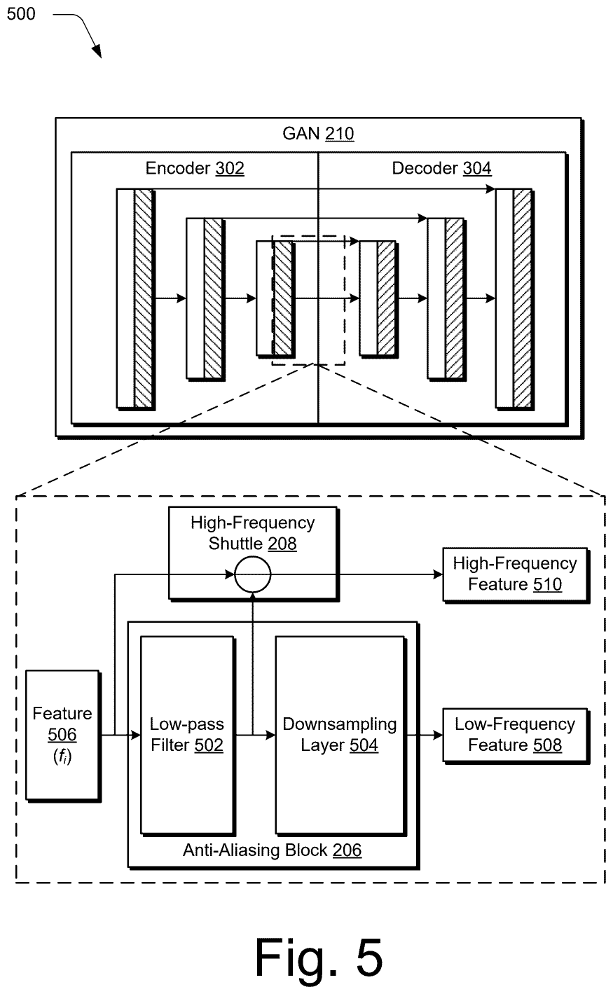

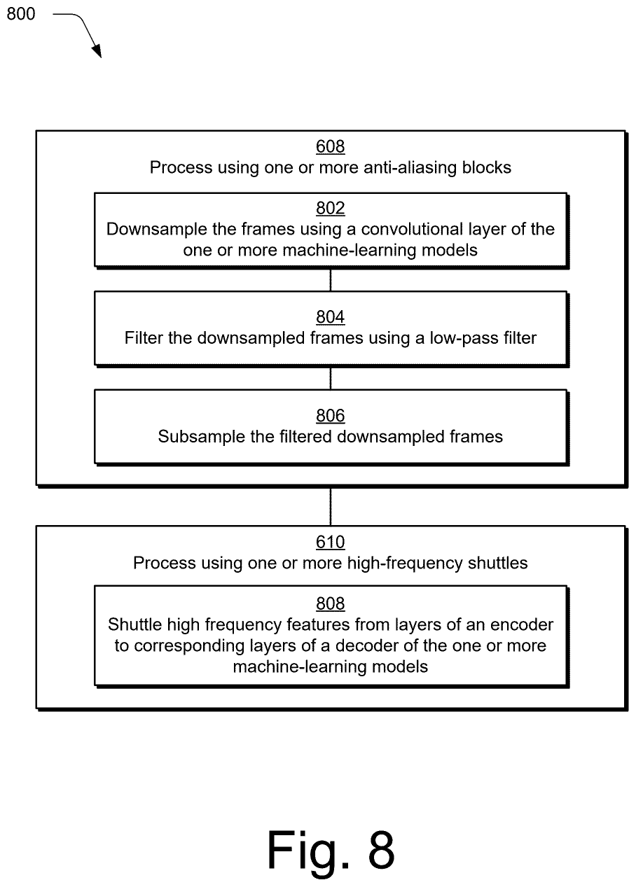

Accordingly, in this example anti-aliasing blocks are introduced to replace strided convolution layers in an upsampling encoder. Downsampling, for instance is employed and followed by use of a low-pass filter and subsampling operation instead of using a strided convolution a convolution with a stride of one as performed in conventional techniques. In real world scenarios, these techniques have shown significant operational improvements in maintaining temporal consistency and mitigation of temporal flickering when compared with conventional naïve strided convolutions. Further discussion of operation of the anti-aliasing blocks may be found in relation to FIGS. 5 and 8.

In a further example, a high-frequency shuttle is employed to address visual artifacts such as blurriness in changing a resolution of frames of a digital video. Visual artifacts, for instance, may be introduced by the flow guided feature propagation module and/or the anti-aliasing block caused by removal of high-frequency information to reduce flicker.

Accordingly, in this example the high-frequency shuttle is usable to leverage skip connections between corresponding encoder and decoder layers of a machine-learning model, e.g., GAN. The high-frequency shuttle is also configurable of leverage a pyramid-like representation of feature maps in an encoder. To do so, the high-frequency shuttle decomposes a feature map into low frequency and high frequency components. The high-frequency feature map containing high-frequency details are injected through a skip connection of the high-frequency shuttle to a corresponding layer of the decoder. As a result, the high-frequency shuttle adds fine-grained details while mitigating against issues such as aliasing, temporal flickering, and so forth. Further discussion of operation of the high-frequency shuttle may be found in relation to FIGS. 5 and 8.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A generative adversarial network, also referred to as a “GAN,” is a type of machine learning model that includes two neural networks, a generator and a discriminator. These two neural networks are trained together in a way that the generator tries to create data that is indistinguishable from real data, while the discriminator tries to distinguish between real and generated data.

In the context of changing the frame resolution of a video, GANs can be used to enhance the resolution of video frames. This process is often referred to as super-resolution. The generator network in the GAN takes low-resolution video frames as input and generates high-resolution frames. The discriminator network then evaluates the quality of the generated high-resolution frames by comparing them to real high-resolution frames. Through this adversarial training process, the generator learns to produce high-quality, high-resolution frames from low-resolution inputs. Once trained, the generator network is then used independent of the discriminator to adjust resolution of frames of an input digital video.

A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Video Resolution Adjustment Environment

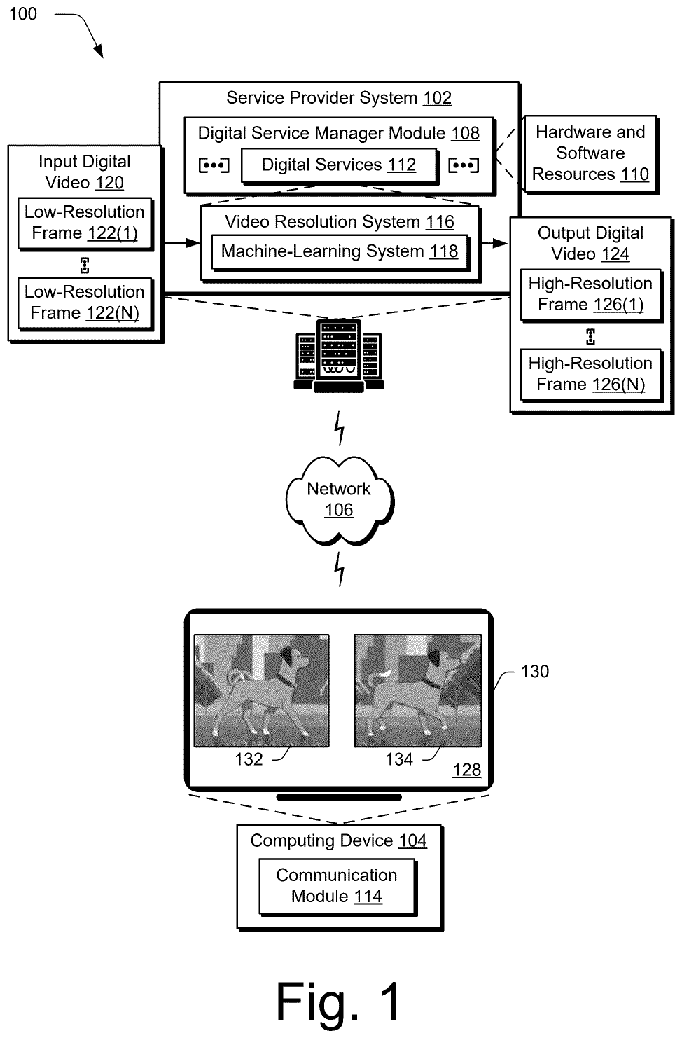

FIG. 1 is an illustration of a digital medium environment 100 in an example implementation that is operable to employ machine learning video resolution adjustment techniques described herein. The illustrated environment 100 includes a service provider system 102 and a computing device 104 that are communicatively coupled, one to another, via a network 106. Computing devices are configurable in a variety of ways.

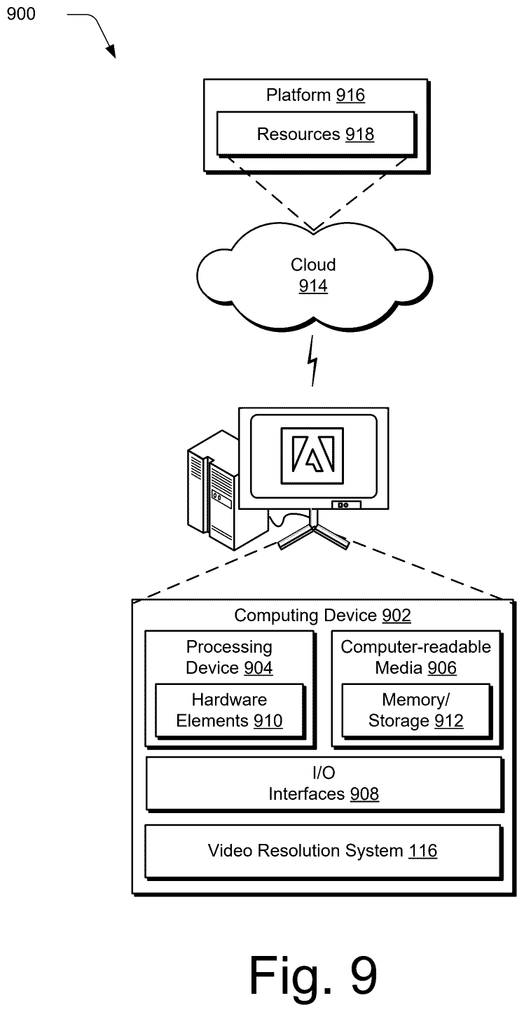

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 9.

The service provider system 102 includes a digital service manager module 108 that is implemented using hardware and software resources 110 (e.g., a processing device and computer-readable storage medium) in support of one or more digital services 112. Digital services 112 in this example are made available, remotely, via the network 106 to computing devices, e.g., computing device 104. Local execution is also contemplated.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a video resolution system 116. The video resolution system 116 employs a machine-learning system 118 having one or more machine-learning models to process an input digital video 120 having low-resolution frames 122(1), . . . , 122(N) to produce an output digital video 124 having high-resolution frames 126(1), . . . , 126(N). In the illustrated example of a user interface 128 as displayed by a display device 130 of the computing device 104, a first example 132 and a second example 134 of frames of a digital video have a resolution adjusted in a manner that maintains temporal consistency, reduces flicker, and support a desired level of detail.

To do so, the video resolution system 116 extends use of resolution adjustment as performed by the machine-learning system 118 (e.g., as a GAN) to employ a generative capability while preserving temporal consistency. In this way, the video resolution system 116 is able to produce an output digital video 124 with high-frequency details and temporal consistency and thereby reduce temporal flickering as encountered by conventional techniques.

An example of resolution adjustment is referred to as video super-resolution (VSR), which is configured to recover high-resolution videos from low-resolution counterparts. As previously described, these techniques encounter additional technical challenges over those techniques used to upsample digital images, solely. These technical challenges include maintaining temporal consistency between frames of a digital video while also generating high-frequency details. Conventional techniques to do so focus on the first challenge, but as a result often produce blurry results that are viewable as visual artifacts. Conventional generative techniques are limited, are unable to hallucinate detailed appearances, and in practice introduce severe temporal flickering typically caused by the added high-resolution details.

Accordingly, the video resolution system 116 is configurable to address these and other technical challenges. The video resolution adjustment techniques, for instance, as implemented by the video resolution system 116 are configurable to change a resolution of frames of a digital video (e.g., to raise or lower) in a manner that supports detailed appearances and realistic textures while maintaining temporal consistency between frames of the digital video. Although the following discussion describes an increase in resolution (e.g., a number of pixels) for frames of an input digital video 120 to produce an output digital video 124, other examples are also contemplated including a resolution reduction as further described in the following section.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Video Resolution Adjustment Using Machine Learning

The following discussion describes machine learning resolution adjustment techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

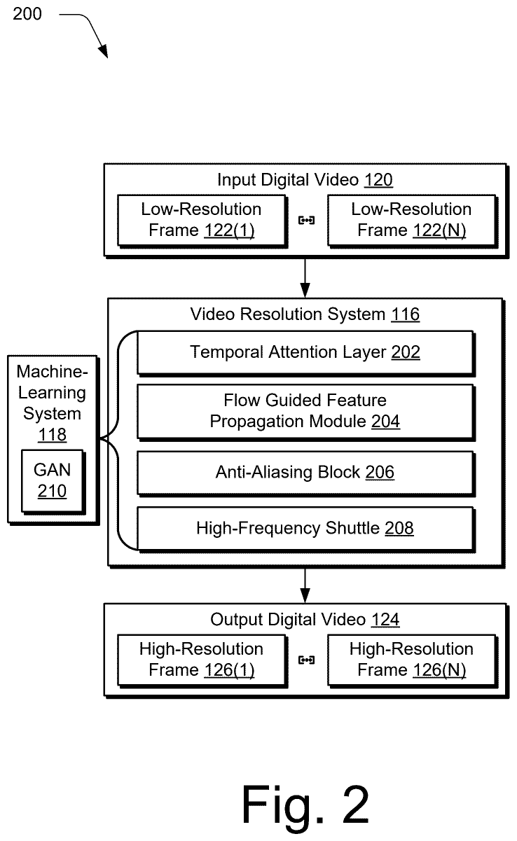

FIG. 2 depicts a system 200 in an example implementation showing operation of the video resolution system 116 of FIG. 1 in greater detail as adjusting resolution of frames of an input digital video 120 to produce an output digital video 124. The video resolution system 116 is configured to address conventional technical challenges in video resolution adjustment through use of the machine-learning system 118 to implement a temporal attention layer 202, a flow guided feature propagation module 204, an anti-aliasing block 206, and a high-frequency shuttle 208. These components may be implemented alone or in combination to improve temporal consistency and accuracy of the video resolution system 116 using a GAN 210, i.e., a generative adversarial network.

The temporal attention layer 202, for instance, is configured to support processing of features of individual frames using spatial self-attention layers which are then jointly processed by a temporal attention layer 202 that is added to a respective layer of a decoder of the GAN 210. The flow guided feature propagation module 204 is configured to encourage information aggregation across different frames of the input digital video 120. The anti-aliasing block 206 is configured to address temporal flickering typically caused by aliased downsampling operations. The high-frequency shuttle 208 is configured to inject high-frequency features into a decoder of the GAN 210. As a result, the high-frequency shuttle 208 is configurable to add fine-grained details to upsampled frames while mitigating against aliasing and temporal flickering.

FIG. 3 depicts a system 300 in an example implementation showing operation of the GAN 210 of FIG. 2 in greater detail as processing low-resolution frames 122(1)-122(N) of the input digital video 120 to form an output digital video 124 having high-resolution frames 126(1)-126(N). In an implementation, a machine-learning model “G” (e.g., GAN 210) upsamples the input digital video 120 as a low-resolution (LR) video “V∈R^{T×h×}^{_{W}}^{×3}” to generate an output digital video 124 as a high-resolution (HR) video “V=G (v),” where “V∈R^{T×H×W×3},” with an upsampling scale factor “α” such that “H=αh, W=αw.” The GAN 210 is configured to upsample frames of the input digital video 120.

The GAN 210 is configurable to support adaptive kernel selection for convolutions and self-attention layers. The GAN 210, for instance, is configurable using an asymmetric U-Net architecture including three downsampling blocks “{Ei}” of an encoder 302 and “3+k” upsampling decoder blocks “{Di}” of a decoder 304.

$$\begin{matrix}X = 𝒢 ( x , z ) = D ( E ( x , z ) , z ) \\ = {\underbrace{{D}_{k + 2} ∘ … {D}_{3}}}_{↑ \times {2}^{k}} ∘ {\underbrace{{D}_{2} ∘ {D}_{1} ∘ {D}_{0}}}_{↑ \times 8} ∘ {\underbrace{{E}_{2} ∘ {E}_{1} ∘ {E}_{0} ( x , z )}}_{↓ \times 8}\end{matrix}$$

Both encoder 302 “E” and decoder 304 “D” blocks are configurable to utilize random spatial noise “z” as a source of stochasticity. The decoder 304 “D” contains spatial self-attention layers. The encoder and decoder block at a corresponding resolution are connected by skip connections of the high-frequency shuttle 208.

In the illustrated example, the flow guided feature propagation module 204 receives, as inputs, the input digital video 120 directly as well as employs a flow estimate from a flow estimator module 306. An anti-aliasing block 206 is included, respectively, with downsampling layers 308 of the encoder 302. Temporal attention layers 202 are used to inflate the image upsampling implemented by the decoder 304 through addition to respective decoder blocks 310. The high-frequency shuttle 208 is used to shuttle high frequency features via skip connection between respective layers of the encoder 302 and the decoder 304, which compensates for detail loss, e.g., caused by blurriness to promote motion consistency.

Issues may arise in conventional techniques in ensuring temporal consistency, mainly due to the high memory cost of three-dimensional layers. For input videos with long sequences of frames, although a digital video may be partitioned into small, non-overlapping chunks to address this cost, temporal flickering may then occur between different chunks. Even within each chunk, a spatial window size of the temporal attention is limited, meaning a large motion (i.e., exceeding the receptive field) is not modeled.

To address these issues, the frames of the input digital video 120 are augmented by the flow guided feature propagation module 204 with features aligned by optical flow generated by the flow estimator module 306. To do so, the flow guided feature propagation module 204 is introduced prior to the GAN 210 instead of directly using the input digital video 120 as input to the GAN 210.

The flow guided feature propagation module 204 is configured to employ a bi-directional recurrent neural network (e.g., RNN 312) and an image backward warping layer, e.g., backward warping layer 314. The flow estimator module 306 is configured to predict bi-directional optical flow maps from the input digital video 120. Subsequently, these maps and the original frame pixels are fed into the RNN 312 of the flow guided feature propagation module 204 to learn temporal-aware features. These features are explicitly warped using the backward warping layer 314, guided by the pre-computed optical flows, before being fed into the GAN 210. In this way, the flow-guided propagation module can effectively handle large amounts of motion and supports improved temporal consistency in output videos.

During training, the flow guided feature propagation module 204 is trained jointly with the GAN 210. The GAN 210 is configurable to employ non-saturating GAN loss, R1 regularization, learned perceptual image patch similarity (LPIPS), and Charbonnier loss during the training:

$$ℒ ( {X}_{t} , {x}_{t} ) = {μ}_{GAN} {ℒ}_{GAN} ( 𝒢 ( {x}_{t} ) , 𝒟 ( 𝒢 ( {x}_{t} ) ) ) + {μ}_{R 1} {ℒ}_{R 1} ( 𝒟 ( {X}_{t} ) ) + {μ}_{LPIPS} {ℒ}_{LPIPS} ( {X}_{t} , {x}_{t} ) + {μ}_{Char} {ℒ}_{Char} ( {X}_{t} , {x}_{t} ) ,$$

where Charbonnier loss is a smoothed version of pixelwise “l₁” loss, “μGAN,” “μR1,” “μLPIPS,” “μChar” are the scales of different loss functions, “xt” represents a frame of the input digital video 120, and “Xt” is a corresponding ground truth high-resolution frame. In an implementation, the loss is average over each of the frames in a clip from the input digital video 120 during training.

At inference, given the input digital video 120 with an arbitrary number of frames, frame features are first generated using the flow guided feature propagation module 204 to augment the frames of the input digital video 120. The frame features are then partitioned into non-overlapping chunks and the GAN 210 processes each chunk independently. Because the features inside each chuck are aware of the other chunks through use of the augmented frame features, temporal consistency between consecutive chunks is preserved.

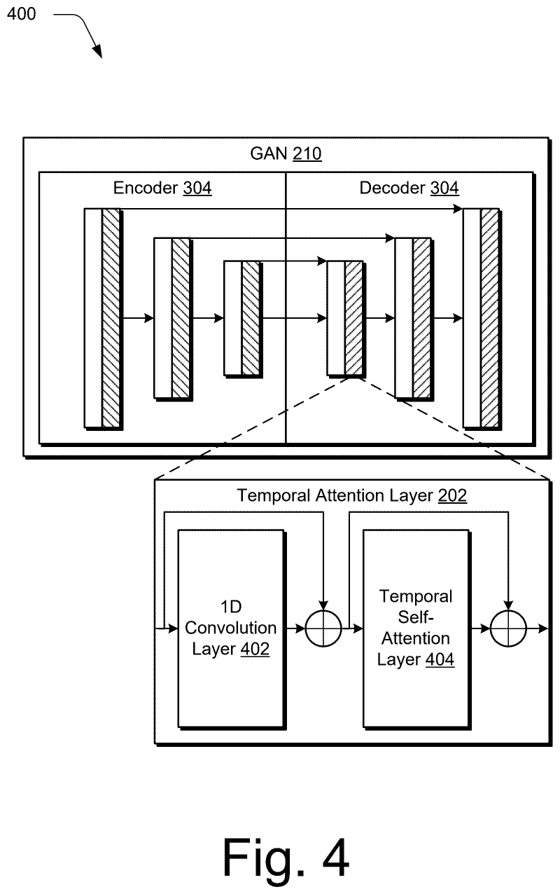

FIG. 4 depicts a system 400 in an example implementation showing operation of the temporal attention layer 202 of FIG. 2 in greater detail as implemented in a decoder 304 of the GAN 210. To adapt a pretrained two-dimensional digital image model for video tasks, a conventional approach is to inflate two-dimensional spatial modules into three-dimensional temporal modules. To reduce the memory cost, instead of directly using three-dimensional convolutional layers in each block, the temporal attention layer 202 is configured to employ a one-dimensional temporal convolution layer 402 that solely operates on the temporal dimension of kernel size three, followed by a temporal self-attention layer 404 that is independent of a spatial receptive field. Both one-dimensional temporal convolution and temporal self-attention are inserted after the spatial self-attention with residual connection.

Therefore, at each block “Di,” the features of individual video frames are processed by the GAN 210 using a spatial self-attention layer and then jointly processed by the temporal attention layer 202. Adding the temporal attention layer 202 to the decoder 304 “D” of the generator “G” operates to improve video consistency. A discriminator “D” is also configurable with comparable temporal attention layers 202. In an implementation, both temporal convolutions and temporal self-attention layers are initialized with zero weights, such that “G” and “D” perform the same as an image up-sampler at the beginning of the training, leading to a smoother transition to a video up-sampler.

FIG. 5 depicts a system 500 in an example implementation showing operation of the anti-aliasing block 206 of FIG. 2 in greater detail. With both temporal and feature propagation modules enabled using the temporal attention layer 202 and the flow guided feature propagation module 204, respectively, the video resolution system 116 is configurable to process longer videos and produce results with increased temporal consistency in comparison with conventional techniques.

In some instances, however, high-resolution frames may exhibit flickering in areas with high-frequency details. It has been identified through the techniques described herein that the downsampling operations in the encoder may contribute to the flickering of those regions. The high-frequency components in the input, for instance, can alias into lower frequencies due to a mismatch between a downsampling rate and sampling criterion. The aliasing of pixels manifests as temporal flickering in video super-resolution. Conventional techniques typically employ regression-based objectives, which tend to remove high-frequency details. Consequently, these conventional techniques produce output videos free of aliasing. Additionally, in a GAN-based framework, the GAN training objectives favor the hallucination of high-frequency details thereby further increasing technical challenges caused by aliasing.

Accordingly, in the anti-aliasing block 206 described herein during downsampling, instead of simply using a strided convolution, a convolution with a stride of one is utilized followed by a low-pass filter and a subsampling operation as implemented by a low-pass filter 502 and a downsampling layer 504 to process feature 506 to produce low-frequency feature 508.

The high-frequency shuttle 208 is configured to communicate the feature 506 from respective layers of the encoder 302 to corresponding layers of the 304 as high-frequency features 510. The high-frequency information supplied by the high-frequency shuttle 208 using the high-frequency features 510 aids to compensate for the loss of high-frequency details, e.g., as caused by the anti-aliasing block 206 and/or the flow guided feature propagation module 204.

In the context of a neural network, a low pass filter 502 is used to remove high-frequency content from an image or signal. Removal of the high-frequency content causes blurring, however, because the low pass filter 502 smooths out rapid changes in pixel intensity, e.g., by filtering changes that are over a threshold amount. Subsampling is used by the downsampling layer 504 after filtering downsampled frames using the low-pass filter 502 as part of the anti-aliasing block 206 to reduce the resolution of the signal and remove high-frequency components that can cause aliasing. The low-pass filter is used to remove high-frequency components that are above the Nyquist frequency, which is half the sampling rate. After filtering, subsampling is used to reduce the resolution of the signal, e.g., by keeping every “nth” sample. This process effectively reduces the sampling rate and removes high-frequency components that can cause aliasing when the signal is reconstructed.

To guide insertion of the high-frequency details, the high-frequency shuttle 208 leverages skip connections in the GAN 210 and uses a pyramid-like representation for the feature maps in the encoder. For example, at the feature resolution level “i,” the feature map “fᵢ” of the feature 506 map is decomposed into low-frequency feature 508 and high-frequency feature 510 components. The low frequency feature map is obtained via the low-pass filter 502, while the high frequency feature map is computed from the residual of the features 506 having the low-frequency features removed. The high-frequency feature map containing high-frequency features 510 are injected through the skip connection to the decoder 304. In this way, the high-frequency shuttle 208 adds fine-grained details to the upsampled videos while mitigating issues such as aliasing or temporal flickering.

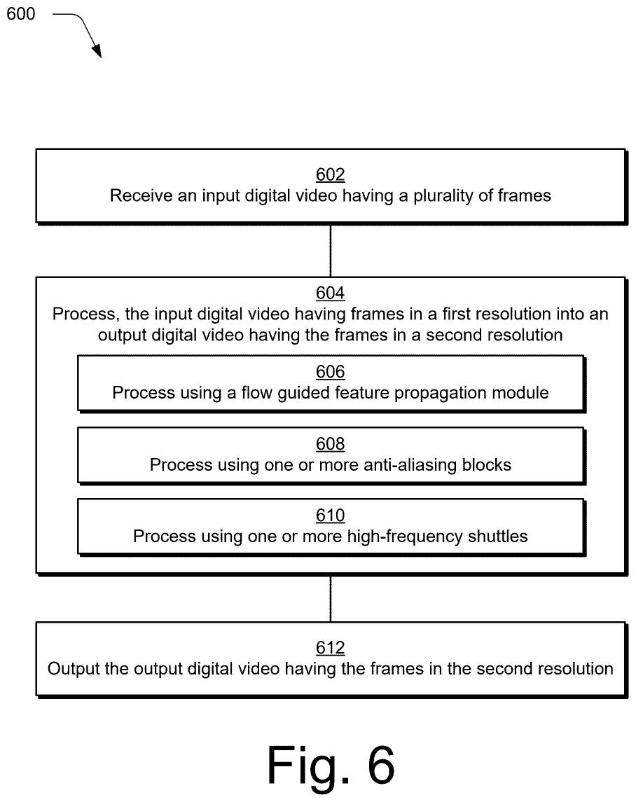

FIG. 6 is a flow diagram depicting an algorithm 600 as a step-by-step procedure in an example implementation of operations performable for accomplishing a result of video resolution adjustment using machine learning. An input digital video is received having a plurality of frames (block 602). An input digital video 120, for instance, is configurable using a variety of formats such as MPEG-4, audio video interleave (AVI), MOV, windows media video (WMV), flash video (FLV), Matroska Video (MKV), WebM, and so forth.

The input digital video having frames in a first resolution is processed into an output digital video having the frames in a second resolution (block 604). In a first example, the input digital video 120 is processed by the video resolution system 116 using a flow guided feature propagation module 204 (block 606). In a second example, the input digital video 120 is processed by the video resolution system 116 using one or more antialiasing blocks 206 (block 608). In a third example, the input digital video 120 is processed by the video resolution system 116 using one or more high-frequency shuttles 208 (block 610). The output digital video 124 is then output by the video resolution system 116 as having frames in a second resolution (block 612).

FIG. 7 is a flow diagram depicting an algorithm 700 as a step-by-step procedure in an example implementation of operations performable for accomplishing a result of video resolution adjustment using flow guided feature propagation. This example described operation of the flow guided feature propagation module 204 of FIG. 6 in greater detail. The flow guided feature propagation module 204 predicts optical flow maps from the plurality of frames of the input digital video (block 702). The flow guided feature propagation module 204 also learns temporal-aware features based on the optical flow maps and pixels of the plurality of frames (block 704). The temporal-aware feature maps are warped as guided by the optical flow maps (block 706). Frames of the digital video are augmented with the warped temporal aware features (block 708). The output digital video is then generate using the augmented frames by a generative adversarial network (GAN) (block 710).

FIG. 8 is a flow diagram depicting an algorithm 800 as a step-by-step procedure in an example implementation of operations performable for accomplishing a result of video resolution adjustment using anti-aliasing blocks and one or more high-frequency shuttles. In order to process the input digital video 120 using the one or more anti-aliasing blocks 206 (block 608), frames are downsampled using a convolutional layer of the one or more machine-learning models (block 802). The downsampled frames are filtered using a low-pass filter 502 (block 804). The filtered downsampled frames are then subsampled (block 806).

In order to process the input digital video 120 using the one or more high-frequency shuttles 208 (block 610), high frequency features are shuttled from layers of an encoder 302 to corresponding layers of a decoder 304 of the one or more machine-learning models (block 808). A variety of other examples are also contemplated.

In this way, video resolution adjustment techniques are configured to change a resolution of frames of a digital video (e.g., to raise or lower) in a manner that supports detailed appearances and realistic textures while maintaining temporal consistency between frames of the digital video, which is not possible in conventional techniques. To do so, a video resolution system 116 is configurable to implement a variety of functionalities. Examples of these functionalities include use of a flow guided feature propagation module 204, anti-aliasing blocks 206, and/or a high-frequency shuttle 208.

### Example System and Device

FIG. 9 illustrates an example system generally at 900 that includes an example computing device 902 that is representative of one or more computing systems and/or devices that implement the various techniques described herein. This is illustrated through inclusion of the video resolution system 116. The computing device 902 is configurable, for example, as a server of a service provider, a device associated with a client (e.g., a client device), an on-chip system, and/or any other suitable computing device or computing system.

The example computing device 902 as illustrated includes a processing device 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 904 is representative of functionality to perform one or more operations using hardware. Accordingly, the processing device 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912 that stores instructions that are executable to cause the processing device 904 to perform operations. The computer-readable storage medium is configured for storing instructions that, responsive to execution by the processing device, causes the processing device to perform operations. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing device 904. The instructions and/or functions are executable/operable by one or more articles of manufacture (for example, one or more computing devices 902 and/or processing devices 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

In implementations, the platform 916 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving an input digital video having a plurality of frames;
processing, by one or more machine-learning models using a processing device, the input digital video having frames in a first resolution into an output digital video having the frames in a second resolution using a flow guided feature propagation module, the processing including:
predicting optical flow maps from the plurality of frames of the input digital video;
learning temporal-aware features based on the optical flow maps and pixels of the plurality of frames; and
warping the temporal-aware features guided by the optical flow maps; and
outputting the output digital video having the frames in the second resolution.

2. The method as described in claim 1, wherein the optical flow maps are bi-directional optical flow maps predicted using an optical flow estimator of the one or more machine-learning models.

3. The method as described in claim 1, wherein the learning is performed using a recurrent neural network (RNN) of the one or more machine-learning models.

4. The method as described in claim 1, wherein the warping is performed using a backward warping layer of the one-or-more machine-learning models that is guided by the optical flow maps.

5. The method as described in claim 1, wherein the processing augments the frames of the input digital video with the warped temporal-aware features aligned by optical flow.

6. The method as described in claim 5, wherein the processing further comprises generating the output digital video having frames in the second resolution using the frames of the input digital video augmented with the temporal-aware features aligned by the optical flow.

7. The method as described in claim 6, wherein the generating the output digital video is performed using a generative adversarial network (GAN) of the one or more machine-learning models.

8. The method as described in claim 7, wherein the generative adversarial network (GAN) is jointly trained with the flow guided feature propagation module.

9. A computing device comprising:
a processing device; and
a computer-readable storage medium storing instruction that, responsive to execution by the processing device, causes the processing device to perform operations including processing, by one or more machine-learning models, an input digital video having frames in a first resolution into an output digital video having the frames in a second resolution, one or more machine-learning models including:
one or more anti-aliasing blocks in an encoder of the one or more machine-learning models to generate low frequency features by removing high-frequency content from the frames of the input digital video; and
one or more high-frequency shuttles configured to shuttle high frequency features from layers of the encoder to corresponding layers of a decoder of the one or more machine-learning models.

10. The computing device as described in claim 9, wherein the anti-aliasing blocks are included along with respective convolutional layers of an encoder of the one or more machine-learning models.

11. The computing device as described in claim 9, wherein the anti-aliasing blocks are configured to removes changes in pixel intensity over a threshold amount from the frames of the input digital video.

12. The computing device as described in claim 9, wherein the one or more machine-learning models include a generative adversarial network (GAN).

13. The computing device as described in claim 12, wherein the generative adversarial network (GAN) is jointly trained with a flow guided feature propagation module.

14. The computing device as described in claim 13, wherein the flow guided feature propagation module is configured to:
predict optical flow maps from the frames of the input digital video;
learn temporal-aware features based on the optical flow maps and pixels of the frames; and
warp the temporal-aware features guided by the optical flow maps.

15. One or more computer-readable storage media storing instructions that, responsive to execution by a processing device, causes the processing device to perform operations comprising:
processing, by one or more machine-learning models, an input digital video having frames in a first resolution into an output digital video having the frames in a second resolution, the processing employing one or more anti-aliasing blocks configured to perform operations including:
downsampling the frames using a convolutional layer of the one or more machine-learning models;
filtering the downsampled frames using a low-pass filter; and
subsampling the filtered downsampled frames; and
outputting the output digital video having the frames in the second resolution.

16. The one or more computer-readable storage media as described in claim 15, wherein the one or more anti-aliasing blocks are included along with respective convolutional layers of an encoder of the one or more machine-learning models.

17. The one or more computer-readable storage media as described in claim 15, wherein the filtering the downsampled frames using the low-pass filter removes high-frequency content from the frames of the input digital video.

18. The one or more computer-readable storage media as described in claim 15, wherein the filtering the downsampled frames using the low-pass filter removes changes in pixel intensity over a threshold amount from the frames of the input digital video.

19. The one or more computer-readable storage media as described in claim 15, wherein the processing includes using a a flow guided feature propagation module, the processing including:
predicting optical flow maps from the frames of the input digital video;
learning temporal-aware features based on the optical flow maps and pixels of the frames; and
warping the temporal-aware features guided by the optical flow maps.

20. The one or more computer-readable storage media as described in claim 15, wherein the one or more machine-learning models include:
one or more anti-aliasing blocks in an encoder of the one or more machine-learning models to generate low frequency features by removing high-frequency content from the frames of the input digital video; and
one or more high-frequency shuttles configured to shuttle high frequency features from layers of the encoder to corresponding layers of a decoder of the one or more machine-learning models.
